(19) United States
(12) Patent Application Publication
(10) Pub. No.: US 2025/0321875 A1
(43) Pub. Date: Oct. 16, 2025

(54) TEST METHOD, SYSTEM, COMPUTER EQUIPMENT AND STORAGE MEDIUM

(71) Applicant: Beijing Youzhuju Network Technology Co., Ltd., Beijing (CN)

(72) Inventors: Chen CHEN, Beijing (CN); Chao ZHANG, Beijing (CN); Jingtian GU, Beijing (CN)

(21) Appl. No.: 19/035,391

(22) Filed: Jan. 23, 2025

(30) Foreign Application Priority Data
Jan. 23, 2024 (CN) 202410095333.0

(51) Int. Cl. G06F 11/3698

(52) U.S. Cl. CPC G06F 11/3698

(57) ABSTRACT

The present disclosure relates to the field of Internet technologies, and discloses a method and system, a computer device, and a storage medium for testing. The method includes: when a first test request is received, obtaining interface information of a target interface of a target business, and obtaining background knowledge information of the target business; sending, to a pre-trained language model, the interface information of the target interface, the background knowledge information, and a first prompt, and receiving, from the pre-trained language model, a first test step set of the target interface, where the first test step set is generated by the pre-trained language model based on the background knowledge information, the interface information of the target interface, and the first prompt.

### CROSS-REFERENCE TO RELATED APPLICATION(S)

This application claims priority to Chinese Application No. 202410095333.0 filed Jan. 23, 2024, the disclosure of which is incorporated herein by reference in its entirety.

### FIELD

The present disclosure relates to the field of Internet technologies, and in particular, to a method and system, a computer device, and a storage medium for testing.

### BACKGROUND

Testing of an interface of an application (for example, an app) is a key step in operation and maintenance of the application.

### SUMMARY

In view of the above, embodiments of the present disclosure provide a method, a system, a computer device, and a storage medium for testing for the purpose of solving the problem of low test efficiency of an interface.

In a first aspect, an embodiment of the present disclosure provides a method for testing, the method comprising: when receiving a first test request, obtaining interface information of a target interface of a target business, and obtaining background knowledge information of the target business; sending, to a pre-trained language model, the interface information of the target interface, the background knowledge information, and a first prompt, and receiving, from the pre-trained language model, a first test step set of the target interface, and the first test step set is generated by the pre-trained language model based on the background knowledge information, the interface information of the target interface, and the first prompt, and the first prompt is used to prompt the pre-trained language model to generate a test step of the target interface based on the background knowledge information and the interface information of the target interface; and executing at least some of test steps in the first test step set.

In the test method provided in the embodiment of the present disclosure, the pre-trained language model is used to automatically generate the first test step set of the target interface, and the first test step set of the target interface is executed, without the need for a user to write test steps, thereby improving test efficiency of the interface.

In a second aspect, an embodiment of the present disclosure provides a system for testing, the system comprising: an interaction platform unit, configured to: when receiving a first test request, obtain interface information of a target interface of a target business, and obtain background knowledge information of the target business; a prompt engineering unit, configured to: when receiving the first test request, send a first prompt to a pre-trained language model, and the first prompt is used to prompt the pre-trained language model to generate a test step of the target interface based on the background knowledge information and the interface information of the target interface; and a traversal engine unit, configured to receive a first test step set of the target interface from the pre-trained language model; and execute at least some of test steps in the first test step set.

In a third aspect, an embodiment of the present disclosure provides a computer device, comprising: a memory and a processor, and the memory and the processor are connected to each other through communication, computer instructions are stored in the memory, and the processor performs the method according to the first aspect or any of the corresponding implementation manners thereof by executing the computer instructions.

In a fourth aspect, an embodiment of the present disclosure provides a computer-readable storage medium, wherein the computer-readable storage medium stores computer instructions, and the computer instructions cause a computer to execute the method according to the first aspect or any of the corresponding implementation manners thereof.

### BRIEF DESCRIPTION OF THE DRAWINGS

In order to more clearly describe the specific embodiments of the present disclosure or the technical solutions in the prior art, the following briefly describes the accompanying drawings required for describing the specific embodiments or the prior art. It is obvious that the accompanying drawings in the following description are some embodiments of the present disclosure. For those of ordinary skill in the art, other drawings may be obtained based on these drawings without creative efforts.

FIG. 1 is a schematic structural diagram of an example of a test system according to an embodiment of the present disclosure;

FIG. 2 is a schematic flowchart of a test method according to an embodiment of the present disclosure;

FIG. 3 is a schematic flowchart of a test scenario;

FIG. 4 is a schematic flowchart of another test method according to an embodiment of the present disclosure;

FIG. 5 is a schematic flowchart of another test scenario;

FIG. 6 is a schematic flowchart of still another test scenario; and

FIG. 7 is a schematic diagram of a hardware structure of a computer device according to an embodiment of the present disclosure.

### DETAILED DESCRIPTION

In order to make the objectives, technical solutions, and advantages of the embodiments of the present disclosure clearer, the technical solutions in the embodiments of the present disclosure will be described clearly and completely below with reference to the accompanying drawings in the embodiments of the present disclosure. It is obvious that the described embodiments are some embodiments of the present disclosure, but not all of the embodiments. Based on the embodiments in the present disclosure, all other embodiments obtained by a person of ordinary skill in the art without creative efforts shall fall within the protection scope of the present disclosure.

Currently, test steps are typically written by a user. The user is required to write a large number of test steps, thus resulting in low test efficiency of the interface. Thus improving test efficiency of the interface has become a problem that requires a solution.

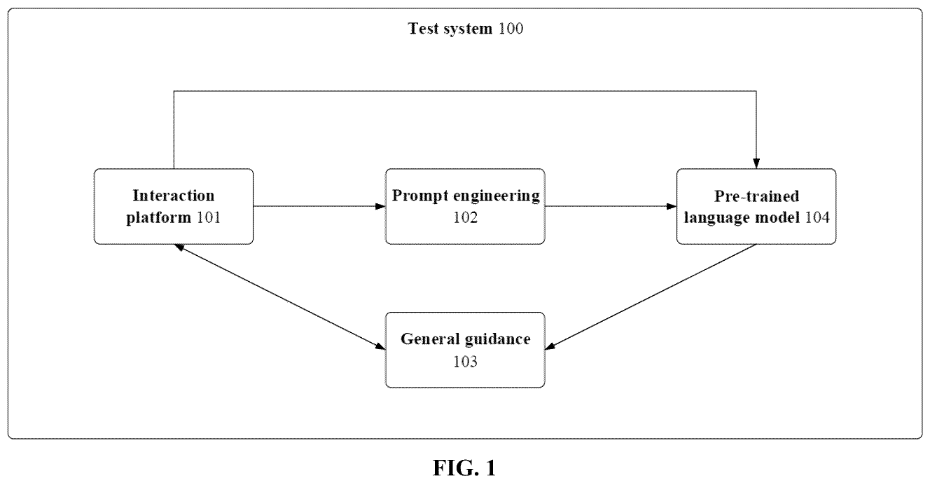

FIG. 1 is a schematic structural diagram of an example of a test system according to an embodiment of the present disclosure.

The test system 100 includes: an interaction platform 101, prompt engineering 102, a traversal engine 103, and a pre-trained language model 104. The pre-trained language model 104 may specifically be a pre-trained language model that may be guided by a prompt to generate an output.

The interaction platform 101 receives a test request from a user device. The interaction platform 101 obtains, based on the test request, interface information of an interface of a target business and information for generating a test step of the interface of the target business, where the interface information of the interface of the target business is obtained by the traversal engine 103 and then forwarded to the interaction platform 101 by the traversal engine 103. The interaction platform 101 sends the information for generating the test step of the interface of the target business to the pre-trained language model 104.

The prompt engineering 102 generates a prompt based on a test step generation manner indicated by the test request. The prompt engineering 102 sends the generated prompt to the pre-trained language model 104.

The pre-trained language model 104 generates a test step set of the interface of the target business based on the interface information of the interface of the target business, the information for generating the test step of the interface of the target business, and the prompt. The pre-trained language model 104 sends the test step set of the interface of the target business to the traversal engine 103, and the traversal engine 103 performs at least some of test steps in the test step set of the interface of the target business.

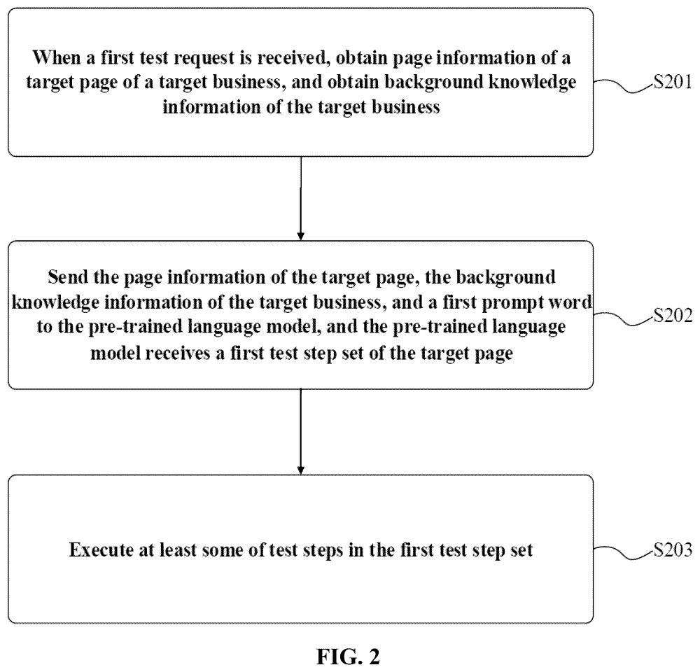

FIG. 2 shows an exemplary flowchart of a test method according to an embodiment of the present disclosure. In step S201, when a first test request is received, interface information of a target interface of a target business and background knowledge information of the target business are obtained. In the embodiment of the present disclosure, if an interface of a business needs to be tested, the business may be used as the target business. For example, the target business is a business for creating an order. The target interface of the target business may be any interface of the target business.

When the first test request is received, steps S201 to S203 may be sequentially performed for each interface of the target business. The first test request corresponds to a test step generation manner of generating a test step of the interface of the target business with the background knowledge information of the target business. In an example, the test step generation manner corresponding to the first test request may be referred to as intelligent creation. For example, when the first test request is received, the interface for which S201 to S203 are performed for the first time may be a first interface of the target business. The first interface may be an interface that is first displayed to the user when the user uses the target business.

It should be noted that the generated test steps of each interface of the target business may form a test case of the target business. The first test request may come from a user device. When the user selects to generate the test step of the interface of the target business with the background knowledge information of the target business, the user device may generate the first test request. The first test request may be received from the user device. A unit that interacts with the user, for example, the interaction platform, sends a test interface to the user device, and the test interface is displayed on the user device. Options of test step generation manners of the interface of the target business are included in the test interface. The user selects, from some options of test step generation manners, an option indicating to generate the test step of the interface of the target business with the background knowledge information of the target business. In addition, the user may enter information indicating a business whose interface the user expects to test. In an example, the user inputs “I want to test the interface of business A”. The business used as the target business is determined based on the information entered by the user.

The interface information of the target interface may reflect an interface object in the target interface, a position of the interface object in the target interface, and the like. For example, the target interface is an html interface, and the interface information of the target interface includes html code of the target interface.

The background knowledge information of the target business may comprehensively describe overall features of the target business. For example, the background knowledge information of the target business includes description information indicating a purpose of the target business, a business type of the target business, and the like.

The background knowledge information of a plurality of businesses may be collected in advance, to construct a background knowledge information base. At step S201, the background knowledge information of the target business may be obtained from the background knowledge information base.

Step S202: Send, to the pre-trained language model, the interface information of the target interface, the background knowledge information of the target business, and a first prompt, and receive, from the pre-trained language model, a first test step set of the target interface. The pre-trained language model in the embodiments of the present disclosure may specifically be a pre-trained language model that may be guided by a prompt to generate an output. The first test step set is generated by the pre-trained language model based on the background knowledge information of the target business, the interface information of the target interface, and the first prompt.

Each test step in the first test step set of the target interface is directed to a different interface object in the target interface. The first prompt is used to prompt the pre-trained language model to generate a test step of the interface of the target business based on the background knowledge information of the target business and the interface information of the interface of the target business. The first prompt may include a preset prompt corresponding to the target business. The preset prompt corresponding to the target business may include a sentence indicating that a test step needs to be generated, and a test-related sentence of an interface object in the interface of the target business. The preset prompt corresponding to the target task may be obtained from a preset prompt base.

For example, the preset prompt corresponding to the target task includes a sentence indicating that a test step needs to be generated: “You are a test expert. You need to generate a test step of the interface of the target business. Please tell me which interface objects should be operated on, which operation should be performed, and what is a value involved in the performed operation”, and a test-related sentence of an interface object in the interface of the target business: “A content format input to an input area of an interface object of type A should be . . . , and a value input to an input area of an interface object of type B must be in an interval of . . . ”.

The first prompt further includes a sentence that may guide the pre-trained language model to generate a test step of the interface of the target business with the interface information of the interface of the target business and the background knowledge information of the target business. For example, the sentence for guiding the pre-trained language model to generate a test step of the interface of the target business with the interface information of the interface of the target business and the background knowledge information of the target business is “Please generate a test step of the interface of the target business based on the interface information of the interface of the target business and the background knowledge information of the target business”.

By sending the interface information of the target interface, the background knowledge information of the target business, and the first prompt to the pre-trained language model, the pre-trained language model may determine, under the guidance of the first prompt and based on overall features of the target business and the interface information of the target interface, which interface objects in the target interface should be operated on, which operation should be performed, and the like, for testing the target interface, to generate the test step set of the target interface that is highly correlated with the business.

In step S203, at least some of test steps in the first test step set are executed. Test steps in the first test step set may be sequentially executed. If one test step in the first test step set is completed and is not the last test step, the next test step of this test step is executed. If one test step in the first test step set cannot be completed due to a specific reason and is not the last test step, this test step is skipped, and the next test step of this test step is executed.

For example, the first test step set sequentially includes test steps 1, 2, 3, and the like. Test step 1 is to click an interface object 1, test step 2 is to select an option from a drop-down option of an interface object 2, and the interface object 2 is a control for selection with a drop-down box. Test step 3 is to enter information in an input area of an interface object 3, and the interface object 3 is a control for entering information with the input area. Test step 1 is first executed, test step 2 is executed after test step 1 is executed, and test step 3 is executed after test step 2 is executed.

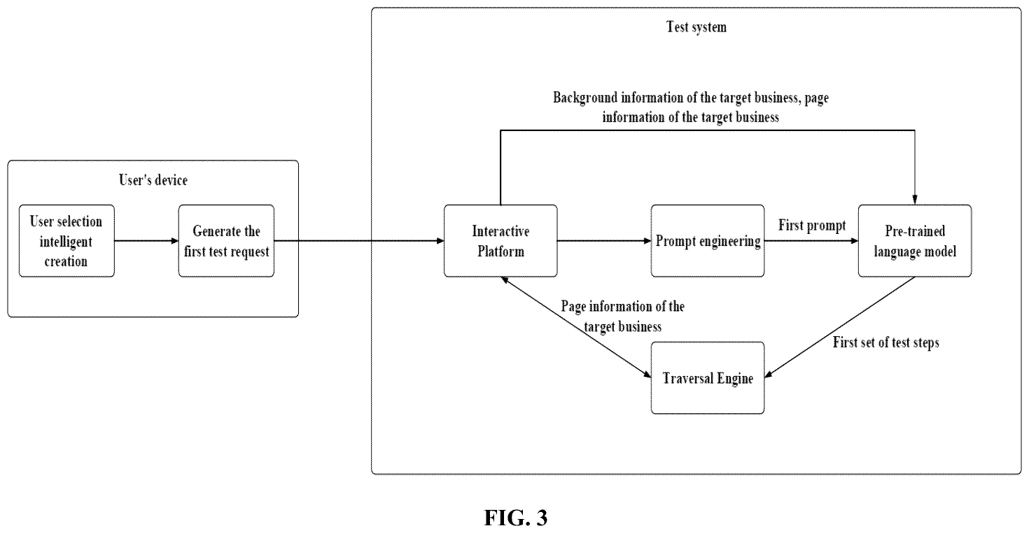

FIG. 3 shows a schematic flowchart of a test scenario. In this test scenario, a test interface is displayed on a user device. Options of test step generation manners of the interface of the target business are included in the test interface. The user selects intelligent creation from some options of test step generation manners. That the user selects intelligent creation means that the user hopes that the pre-trained language model generates a test step of the interface of the target business with the background knowledge information of the target business. After the user selects intelligent creation, the user device may generate a first test request. The user device sends the first test request to the interaction platform. The interaction platform obtains interface information of a target interface of a target business, and obtains background knowledge information of the target business.

When the interaction platform obtains the interface information of the target interface of the target business, the interaction platform sends a request to trigger the traversal engine to obtain the interface information of the target interface from a server where the interface information of the target interface of the target business is located, and the interaction platform receives the interface information of the target interface returned by the traversal engine. The interaction platform sends the interface information of the target interface and the background knowledge information of the target business to the pre-trained language model. The prompt engineering sends a first prompt to the pre-trained language model. The pre-trained language model generates a first test step set based on the interface information of the target interface, the background knowledge information of the target business, and the first prompt. The traversal engine receives the first test step set of the target interface from the pre-trained language model, and the traversal engine performs the first test step set.

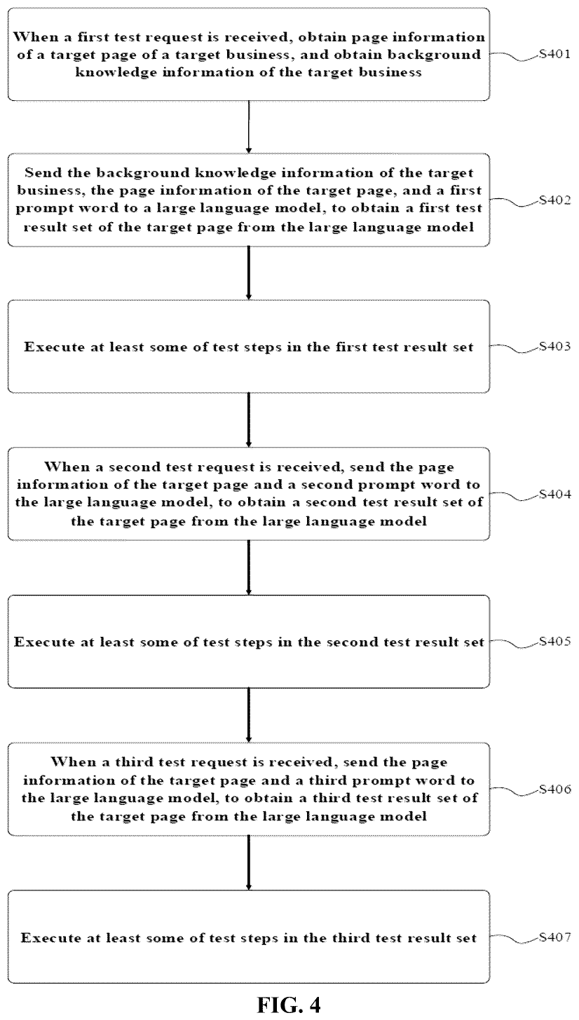

FIG. 4 shows an exemplary flowchart of another test method according to an embodiment of the present disclosure. It should be noted that steps S401 to S403 are performed when a first test request is received, steps 404 to 405 are performed when a second test request is received, and steps 406 to 407 are performed when a third test request is received. There is no execution sequence relationship between steps S401 to S403, steps 404 to 405, and steps 406 to 407.

At step S401, when a first test request is received, interface information of a target interface of a target business is obtained, and background knowledge information of the target business is obtained. For the process of step S401, refer to the process of step S201, as the details are not described herein again.

At step S402, the background knowledge information of the target business, the interface information of the target interface, and the first prompt are sent to the pre-trained language model, and the first test step set of the target interface is received from the pre-trained language model. For the process of step S402, refer to the process of step S202, as the details are not described herein again.

At step S403, at least some of test steps in the first test step set are executed. For some processes of step S403, refer to the process of step S203, as the details are not described herein again.

In a possible implementation, after step S403 is performed, at least some of test steps in the first test step set may be stored in a database for storing historical test steps of the target interface. In this way, if in subsequent testing of the target interface, the user selects to generate a test step of the target interface with the historical test steps of the target interface again, the at least some of test steps in the first test step set may be used as the historical test steps of the target interface.

In a possible implementation, the target interface is displayed with a browser during execution of at least some of test steps in the first test step set of the target interface; and when each of at least some of the first test step set of the target interface is completed, a screenshot of the target interface is taken to obtain a test effect image indicating a test effect of the target interface. In this way, the test effect image may be sent by the traversal engine to the interaction platform, and then forwarded by the interaction platform to the user device. The user may view the test effect image, and the user views the test effect of the target interface by viewing the test effect image.

In a possible implementation, executing at least some of test steps in the first test step set of the target interface comprises: determining whether there is an inexecutable test step in the first test step set of the target interface; if yes, sending, to the pre-trained language model, notification information corresponding to the first test step set, to instruct the pre-trained language model to regenerate a new test step for an interface object for which the inexecutable test step in the first test step set is directed; receiving the new test step from the pre-trained language model; and when determining that the new test step is executable, executing an executable test step and the new test step in the first test step set, and the executable test step is a test step other than the inexecutable test step in the first test step set.

The inexecutable test step may be a test step that cannot be executed. The determination of whether there is an inexecutable test step in the first test step set of the target interface considers that a generated test step may be inexecutable due to a specific reason, for example, the pre-trained language model may occasionally encounter a situation called model hallucination. For example, the generated test step is not a test step that can be performed on a type of an interface object for which the test step is directed, resulting in that the generated test step cannot be executed. The instruction to the pre-trained language model to regenerate the new test step for the interface object for which the inexecutable test step in the first test step set is directed and the execution of the new test step when it is determined that the new test step is executable may avoid a situation in which the interface object for which the inexecutable test step in the first test step set is directed is not tested.

In a possible implementation, in response to a jump from the target interface to an associated interface of the target interface, interface information of the associated interface of the target interface is obtained, and the jump occurs after each of at least some of the first test step set of the target interface is completed; the interface information of the associated interface is sent to the pre-trained language model; a test step set of the associated interface of the target interface is received from the pre-trained language model; and at least some of test steps in the test step set of the associated interface are executed. The pre-trained language model generates the test step set of the associated interface based on the interface information of the associated interface, the background knowledge information of the target business, and the first prompt.

After each of at least some of the first test step set of the target interface is completed, the jump from the target interface to the associated interface of the target interface may be performed. For example, after each of at least some of the first test step set of the target interface is completed, a button indicating to submit the target interface in the target interface is clicked, thereby triggering the jump from the target interface to the associated interface of the target interface. When the jump from the target interface to the associated interface of the target interface occurs, the associated interface of the target interface may be automatically tested.

At step S404, when a second test request is received, the interface information of the target interface, a historical test step set of the target interface, and a second prompt are sent to the pre-trained language model, and a second test step set of the target interface is received from the pre-trained language model. The target interface of the target business may be any interface of the target business. When the second test request is received, steps S404 to S405 may be sequentially performed for each interface of the target business. For example, when the second test request is received, the interface for which S404 to S405 are performed for the first time may be a first interface of the target business. The first interface may be an interface that is first displayed to the user when the user uses the target business.

The second test step set is generated by the pre-trained language model based on the interface information of the target interface, the historical test step set of the target interface, and the second prompt. Each test step in the second test step set of the target interface is directed to a different interface object in the target interface. The second prompt is used to prompt the pre-trained language model to generate a test step set of the interface of the target business comprising at least one difference test step of the interface of the target business.

For a difference test step i of the target interface, the difference test step i is different from a historical test step in the historical test step set of the target interface that corresponds to the difference test step i, and the difference test step i and the historical test step that corresponds to the difference test step i are for a same interface object in the target interface. The difference test step i is any of the difference test steps of the target interface.

The second prompt may include a preset prompt corresponding to the target business. The preset prompt corresponding to the target business may indicate a requirement for generating a test case and test-related information of an interface object in the interface of the target business. The preset prompt corresponding to the target task may be obtained from a preset prompt base.

The second prompt further includes a sentence that may guide the pre-trained language model to generate a test step of the interface of the target business with the interface information of the interface of the target business and the historical test step set of the interface of the target business. For example, “Please generate a test step of the interface of the target business based on the interface information of the interface of the target business and the historical test step set of the interface of the target business. The historical test step is as follows: for an interface object j in the interface of the target business, the generated test step for the interface object j should be as different as possible from the historical test step for the interface object j”, and the interface object j is any interface object in the interface of the target business that participates in the test.

The second test request may come from a user device. When the user selects to generate the test step of the interface of the target business with the historical test steps of the interface of the target business, the user device may generate the second test request. The second test request may be received from the user device. It should be noted that if the target interface has not been obtained before step S404, the interface information of the target interface is first obtained when the second test request is received. The historical test step set of the target interface may include a historical test step for each interface object in the target interface that participates in the test.

For an interface object j that participates in the test in the target interface, there may be one or more historical test steps for the interface object j that participates in the test. For example, the historical test step set of the target interface may be all historical test steps of the target interface that have been stored.

It should be noted that the historical test step of the target interface is relative to a specific time when the second test request is received. In the kth reception of the second test request, the test step of the target interface that has been executed before the kth reception of the second test request may be used as the historical test step for generating the test step of the target interface when the second test request is received for the kth time.

The second test step set of the target interface includes a test step for each interface object in the target interface that participates in the test. The second test step set includes at least one difference test step of the target interface and at least one non-difference test step of the target interface. The non-difference test step is a test step other than the difference test step in the second test step set.

For a non-difference test step m of the target interface, the non-difference test step m of the target interface is directed to an interface object n that participates in the test, and the non-difference test step m of the target interface may be a historical test step of the target interface for the interface object n. The non-difference test step m may be any non-difference test step.

For example, an interface object A in the target interface is a control for selection with a drop-down box, and the drop-down box of the interface object A includes: an option A, an option B, and an option C. The historical test step set of the target interface includes only one historical test step A for the interface object A, and the historical test step A for the interface object A is to select the option A from the drop-down box of the interface object A. The second test step set includes: a difference test step A corresponding to the historical test step A, and the difference test step A is also directed to the interface object A, but the difference test step A is to select the option B from the drop-down box of the interface object A. The historical test step set of the target interface includes only one historical test step B for an interface object B, the historical test step B for the interface object B is to enter a value B in an input area of the interface object B, and the second test step set includes: a non-difference test step B corresponding to the historical test step B, the non-difference test step B corresponding to the historical test step B is also directed to the interface object B, and the non-difference test step B is also to enter the value B in the input area of the interface object B.

At step S405, at least some of test steps in the second test step set are performed. Test steps in the second test step set may be sequentially performed. If one test step in the second test step set is completed and is not the last test step, the next test step of this test step is executed. If one test step in the second test step set cannot be completed due to a specific reason and is not the last test step, this test step is skipped, and the next test step of this test step is executed.

In a possible implementation, after step S405 is performed, at least some of test steps in the second test step set may be stored in a database for storing historical test steps of the target interface. In this way, if in subsequent testing of the target interface, the user selects to generate a test step of the target interface with the historical test steps of the target interface again, the at least some of test steps in the second test step set may be used as the historical test steps of the target interface.

In a possible implementation, the target interface is displayed with a browser during execution of at least some of test steps in the second test step set of the target interface; and when each of at least some of the second test step set of the target interface is completed, a screenshot of the target interface is taken to obtain a test effect image indicating a test effect of the target interface. In this way, the test effect image may be sent by the traversal engine to the interaction platform, and then forwarded by the interaction platform to the user device. The user may view the test effect image, and the user views the test effect of the target interface by viewing the test effect image.

In a possible implementation, executing at least some of test steps in the second test step set of the target interface comprises: determining whether there is an inexecutable test step in the second test step set of the target interface; if yes, sending, to the pre-trained language model, notification information corresponding to the second test step set, to instruct the pre-trained language model to regenerate a new test step for an interface object for which the inexecutable test step in the second test step set is directed; receiving the new test step from the pre-trained language model; and when it is determined that the new test step is executable, executing an executable test step and the new test step in the second test step set, wherein the executable test step is a test step other than the inexecutable test step in the second test step set.

In a possible implementation, in response to a jump from the target interface to an associated interface of the target interface, interface information of the associated interface of the target interface is obtained, and the jump occurs after each of at least some of the second test step set of the target interface is completed; the interface information of the associated interface and a historical test step set of the associated interface are sent to the pre-trained language model; a test step set of the associated interface of the target interface is received from the pre-trained language model; and at least some of test steps in the test step set of the associated interface are executed. The pre-trained language model generates the test step set of the associated interface based on the interface information of the associated interface, the historical test step set of the associated interface, and the second prompt.

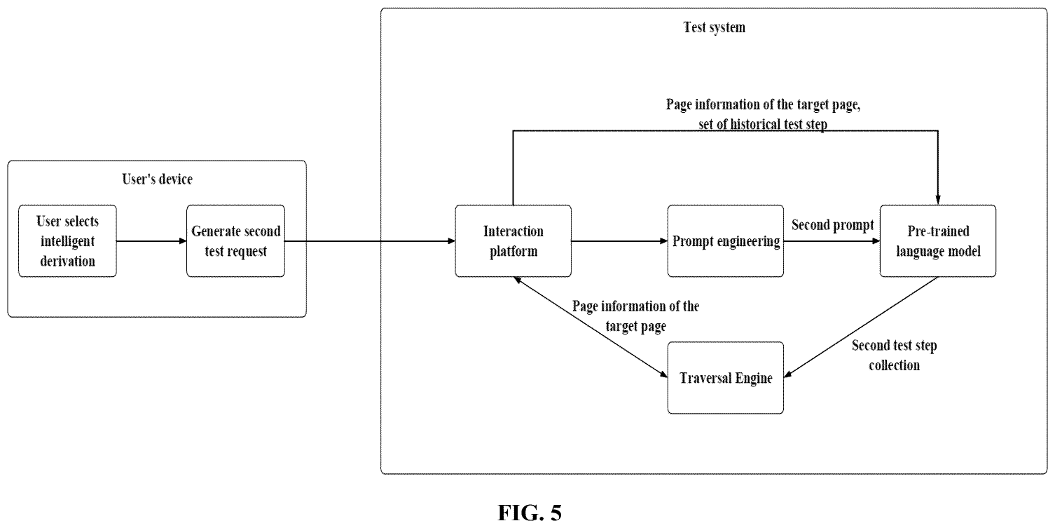

FIG. 5 shows a schematic flowchart of another test scenario. In this test scenario, a test interface is displayed on a user device. Options of test step generation manners of the interface of the target business are included in the test interface. The user selects intelligent derivation from some options of test step generation manners. The user's selection to intelligent derivation means that the user hopes that the pre-trained language model generates a test step of the interface of the target business with the historical test steps of the interface of the target business. After the user selects intelligent derivation, the user device may generate a second test request. The user device sends the second test request to the interaction platform. The interaction platform obtains interface information of a target interface of a target business, and obtains a historical test step set of the target interface.

When the interaction platform obtains the interface information of the target interface of the target business, the interaction platform sends a request to trigger the traversal engine to obtain the interface information of the target interface from a server where the interface information of the target interface of the target business is located, and the interaction platform receives the interface information of the target interface returned by the traversal engine. The interaction platform sends the interface information of the target interface and the historical test step set of the target interface to the pre-trained language model. The prompt engineering sends a second prompt to the pre-trained language model. The pre-trained language model generates a second test step set of the target interface based on the interface information of the target interface, the historical test step set of the target interface, and the second prompt. The traversal engine receives the second test step set of the target interface from the pre-trained language model, and the traversal engine performs the second test step set.

At step S406, when a third test request is received, the interface information of the target interface and a third prompt are sent to the pre-trained language model, and a third test step set of the target interface is received from the pre-trained language model. The target interface of the target business may be any interface of the target business.

When the third test request is received, steps S406 to S407 may be sequentially performed for each interface of the target business. For example, when the third test request is received, the interface for which S406 to S407 are performed for the first time may be a first interface of the target business. The first interface may be an interface that is first displayed to the user when the user uses the target business.

The third test request may come from a user device. When the user selects to generate the test step of the interface of the target business in a random manner, the user device may generate the third test request. The third test request may be received from the user device. The third test step set is generated by the pre-trained language model based on the interface information of the target interface and the third prompt, and the third prompt is used to prompt the pre-trained language model to generate the test step set of the target interface in the random manner.

Generating the test step set of the target interface in the random manner may include: randomly selecting each interface object in the target interface that participates in the test, randomly selecting one interface object in the target interface that participates in the test each time, and generating a test step for the selected interface object that participates in the test. Generating the test step set of the target interface in the random manner may be equivalent to imitating a user behavior for an interface object in the target interface, and testing the target interface with the test step set of the target interface that is randomly generated, that is, the third test step set, so that high coverage test of the target interface can be implemented, and overall reliability of the target interface is verified.

At step S407, at least some of test steps in the third test step set are executed. Test steps in the third test step set may be sequentially executed. If one test step is completed and is not the last test step, the next test step of this test step is executed. If one test step cannot be completed due to a specific reason and is not the last test step, this test step is skipped, and the next test step of this test step is executed.

In a possible implementation, after step S407 is performed, at least some of test steps in the third test step set may be stored in a database for storing historical test steps of the target interface. In this way, if in subsequent testing of the target interface, the user selects to generate a test step of the target interface with the historical test steps of the target interface again, the at least some of test steps in the third test step set may be used as the historical test steps of the target interface.

In a possible implementation, the target interface is displayed with a browser during execution of at least some of test steps in the third test step set of the target interface; and when each of at least some of the third test step set of the target interface is completed, a screenshot of the target interface is taken to obtain a test effect image indicating a test effect of the target interface. In this way, the test effect image may be sent by the traversal engine to the interaction platform, and then forwarded by the interaction platform to the user device. The user may view the test effect image, and the user views the test effect of the target interface by viewing the test effect image.

In a possible implementation, executing at least some of test steps in the third test step set of the target interface comprises: determining whether there is an inexecutable test step in the third test step set of the target interface; if yes, sending, to the pre-trained language model, notification information corresponding to the third test step set, to instruct the pre-trained language model to regenerate a new test step for an interface object for which the inexecutable test step in the third test step set is directed; receiving the new test step from the pre-trained language model; and when it is determined that the new test step is executable, executing an executable test step and the new test step in the third test step set, wherein the executable test step is a test step other than the inexecutable test step in the third test step set.

In a possible implementation, in response to a jump from the target interface to an associated interface of the target interface, interface information of the associated interface of the target interface is obtained, and the jump occurs after each of at least some of the third test step set of the target interface is completed; the interface information of the associated interface is sent to the pre-trained language model; a test step set of the associated interface of the target interface is received from the pre-trained language model; and at least some of test steps in the test step set of the associated interface are executed. The pre-trained language model generates the test step set of the associated interface based on the interface information of the associated interface and the third prompt.

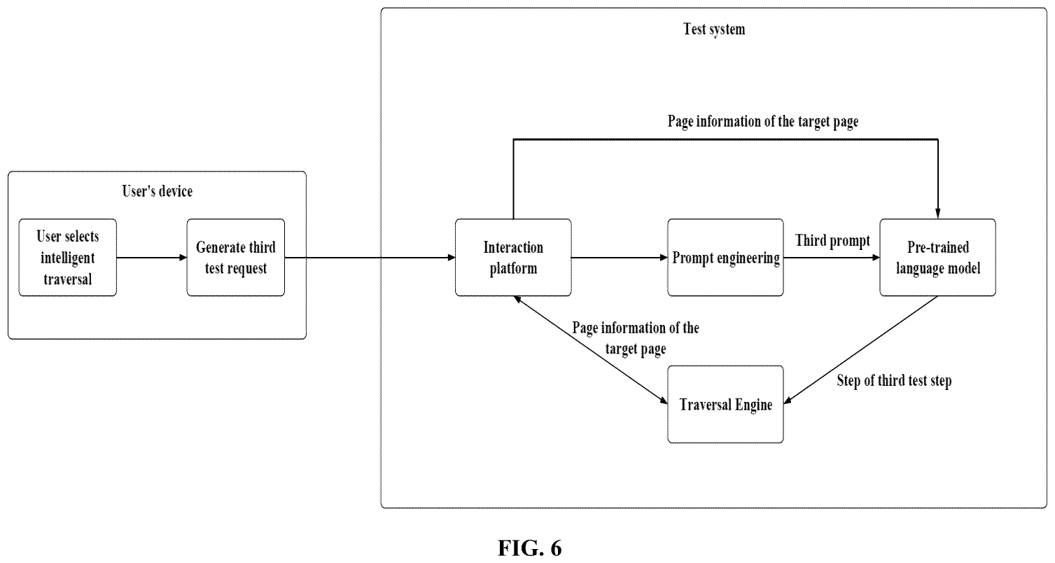

FIG. 6 shows a schematic flowchart of still another test scenario. In this test scenario, a test interface is displayed on a user device. Options of test step generation manners of the interface of the target business are included in the test interface. The user selects intelligent traversal from some options of test step generation manners. That the user selects intelligent traversal means that the user hopes that the pre-trained language model generates a test step of the interface of the target business in a random manner. After the user selects intelligent traversal, the user device may generate a third test request. The user device sends the third test request to the interaction platform. The interaction platform obtains interface information of a target interface of a target business.

When the interaction platform obtains the interface information of the target interface of the target business, the interaction platform sends a request to trigger the traversal engine to obtain the interface information of the target interface from a server where the interface information of the target interface of the target business is located, and the interaction platform receives the interface information of the target interface returned by the traversal engine. The interaction platform sends the interface information of the target interface to the pre-trained language model. The prompt engineering sends a third prompt to the pre-trained language model. The pre-trained language model generates a third test step set based on the interface information of the target interface and the third prompt. The traversal engine receives the third test step set of the target interface from the pre-trained language model, and the traversal engine performs the third test step set.

An embodiment of the present disclosure provides a system for testing, the system comprising: an interaction platform unit, configured to, when a first test request is received, obtain interface information of a target interface of a target business, and obtain background knowledge information of the target business; a prompt engineering unit, configured to, when the first test request is received, send a first prompt to a pre-trained language model, and the first prompt is used to prompt the pre-trained language model to generate a test step of the target interface based on the background knowledge information and the interface information of the target interface; and a traversal engine unit, configured to receive a first test step set of the target interface from the pre-trained language model; and execute at least some of test steps in the first test step set.

In a possible implementation, the interaction platform unit is further configured to, when a second test request is received, send the interface information of the target interface and a historical test step set of the target interface to the pre-trained language model; and the prompt engineering unit is further configured to when the second test request is received, send a second prompt to the pre-trained language model, wherein the second prompt is used to prompt the pre-trained language model to generate a test step set comprising at least one difference test step of the target interface, the difference test step is different from a historical test step in the historical test step set of the target interface that corresponds to the difference test step, and the difference test step and the historical test step that corresponds to the difference test step are for a same interface object in the target interface; and the traversal engine unit is further configured to: receive a second test step set of the target interface from the pre-trained language model; and execute at least some of test steps in the second test step set.

In a possible implementation, the interaction platform unit is further configured to, when a third test request is received, send the interface information of the target interface to the pre-trained language model; and the prompt engineering unit is further configured to, when the third test request is received, send a third prompt to the pre-trained language model, and the third prompt is used to prompt the pre-trained language model to generate a test step set of the target interface in a random manner; and the traversal engine unit is further configured to receive a third test step set of the target interface from the pre-trained language model; and execute at least some of test steps in the third test step set, and the third test step set is generated by the pre-trained language model based on the interface information of the target interface and the third prompt.

In a possible implementation, the traversal engine unit is further configured to: display the target interface with a browser during execution of at least some of test steps in a target test step set of the target interface, and the target test step set is one of the following: the first test step set, the second test step set, and the third test step set; and when each of at least some of the target test step set of the target interface is completed, take a screenshot of the target interface to obtain a test effect image indicating a test effect of the target interface.

In a possible implementation, the test system further comprises: a storage unit, configured to store at least some of test steps in a target test step set of the target interface in a database for storing historical test steps of the target interface, and the target test step set is one of the following: the first test step set, the second test step set, and the third test step set.

In a possible implementation, the traversal engine unit is further configured to, determine whether there is an inexecutable test step in a target test step set of the target interface, and the target test step set is one of the following: the first test step set, the second test step set, and the third test step set; and if yes, send, to the pre-trained language model, notification information corresponding to the target test step set, to instruct the pre-trained language model to regenerate a new test step for an interface object for which the inexecutable test step in the target test step set is directed; receive the new test step from the pre-trained language model; and when it is determined that the new test step is executable, execute an executable test step and the new test step in the target test step set, and the executable test step is a test step other than the inexecutable test step in the target test step set.

In a possible implementation, the interaction platform unit is further configured to: in response to a jump from the target interface to an associated interface of the target interface, at least send interface information of the associated interface to the pre-trained language model, and the jump occurs after each of at least some of a target test step set of the target interface is completed, and the target test step set is one of the following: the first test step set, the second test step set, and the third test step set; and the traversal engine unit is further configured to receive a test step set of the associated interface from the pre-trained language model; and execute at least some of test steps in the test step set of the associated interface.

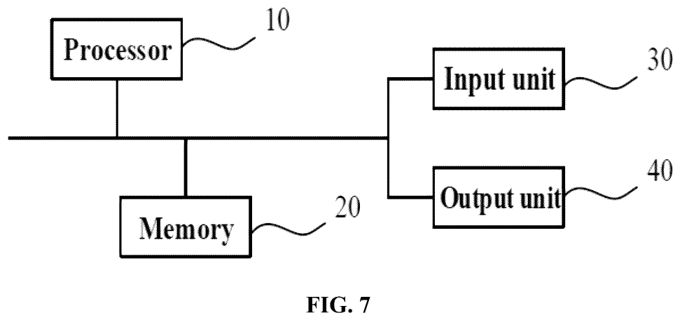

FIG. 7 shows a schematic structural diagram of a computer device according to an embodiment of the present disclosure. The computer device includes: one or more processors 10, a memory 20, and an interface for connecting the components, including a high-speed interface and a low-speed interface. The components communicate with each other and are connected with different buses, and can be mounted on a common mainboard or mounted in other manners as required. The processor can process instructions executed in the computer device, including instructions stored in or on the memory to display graphical information of a GUI on an external input/output apparatus (such as a display apparatus coupled to the interface). In some optional implementations, if required, a plurality of processors and/or a plurality of buses may be used together with a plurality of memories and a plurality of memories. Similarly, a plurality of computer devices may be connected, and each device provides some necessary operations (for example, as a server array, a group of blade servers, or a multi-processor system).

The processor 10 may be a central processing unit, a network processor, or a combination thereof. The processor 10 may further include a hardware chip. The above hardware chip may be an application-specific integrated circuit, a programmable logic device, or a combination thereof. The above programmable logic device may be a complex programmable logic device, a field programmable gate array, a general array logic, or any combination thereof.

The memory 20 stores instructions executable by at least one processor 10, so that the at least one processor 10 performs the method shown in the above embodiments. The memory 20 may include a program storage area and a data storage area. The program storage area may store an operating system and an application program required by at least one service. The data storage area may store data created according to the use of the computer device. In addition, the memory 20 may include a high-speed random access memory, and may further include a non-transitory memory, for example, at least one magnetic disk storage device, a flash memory device, or another non-transitory solid-state storage device. In some optional implementations, the memory 20 may alternatively include a memory remotely disposed relative to the processor 10, and the remote memory may be connected to the computer device through a network. Examples of the above network include, but are not limited to, the Internet, an intranet, a local area network, a mobile communication network, and a combination thereof.

The memory 20 may include a volatile memory, for example, a random access memory. Alternatively, the memory may include a non-volatile memory, for example, a flash memory, a hard disk, or a solid-state drive. Alternatively, the memory 20 may further include a combination of the foregoing types of memories.

The computer device further includes an input unit 30 and an output unit 40. The processor 10, the memory 20, the input unit 30, and the output unit 40 may be connected through a bus or in another manner. The input unit 30 may receive input digit or character information, and generate key signal inputs related to user settings and business control of the computer device, for example, a touchscreen, a keypad, a mouse, a trackpad, a touchpad, an indicator sticks, one or more mouse buttons, a trackball, a joystick, or the like. The output unit 40 may include a display apparatus, an auxiliary lighting apparatus (for example, an LED), a haptic feedback apparatus (for example, a vibration motor), and the like. The display apparatus includes, but is not limited to, a liquid crystal display, a light-emitting diode display, a plasma display, and the like. In some optional implementations, the display apparatus may be a touchscreen. The computer device further includes a communication interface, configured to communicate between the computer device and another device or a communication network.

An embodiment of the present disclosure further provides a computer-readable storage medium. The method according to the embodiment of the present disclosure may be implemented in hardware, firmware, or be implemented as computer code that can be recorded in a storage medium or originally stored in a remote storage medium or a non-transitory machine-readable storage medium and downloaded over a network and stored in a local storage medium, so that the method described herein can be stored in such software processing on a storage medium using a general-purpose computer, a special-purpose processor, or programmable or special-purpose hardware. The storage medium may be a magnetic disk, an optical disc, a read-only memory, a random access memory, a flash memory, a hard disk, a solid-state drive, or the like. Further, the storage medium may further include a combination of the foregoing types of memories. It can be understood that a computer, a processor, a microprocessor, a controller, or programmable hardware includes a storage component that can store or receive software or computer code, and when the software or computer code is accessed and executed by the computer, the processor, or the hardware, the method shown in the above embodiments is implemented.

Although the embodiments of the present disclosure are described with reference to the accompanying drawings, persons of ordinary skill in the art may make various modifications and variations without departing from the spirit and scope of the present disclosure. Such modifications and variations all fall within the scope defined by the appended claims.

What is claimed is:

1. A method for testing, comprising:
in response to receiving a first test request, obtaining interface information of a target interface of a target business, and obtaining background knowledge information of the target business;
sending, to a pre-trained language model, the interface information of the target interface, the background knowledge information, and a first prompt:
receiving, from the pre-trained language model, a first test step set of the target interface, wherein the first test step set is generated by the pre-trained language model and based on the background knowledge information, the interface information of the target interface and the first prompt, and the first prompt being usable to prompt the pre-trained language model to generate a test step of the target interface based on the background knowledge information and the interface information of the target interface; and
executing at least some of test steps in the first test step set.

2. The method of claim 1, wherein the method further comprises:
in response to receiving a second test request, sending, to the pre-trained language model, the interface information of the target interface, a historical test step set of the target interface, and a second prompt;
receiving, from the pre-trained language model, a second test step set of the target interface, wherein the second test step set is generated by the pre-trained language model and based on the interface information of the target interface, the historical test step set of the target interface and the second prompt, the second prompt being usable to prompt the pre-trained language model to generate a test step set comprising at least one difference test step of the target interface, the at least one difference test step being different from a historical test step in the historical test step set that corresponds to the difference test step, and the at least one difference test step and the historical test step that corresponds to the difference test step being for a same interface object in the target interface; and
executing at least some of test steps in the second test step set.

3. The method of claim 2, wherein the method further comprises:
in response to receiving a third test request, sending, to the pre-trained language model, the interface information of the target interface and a third prompt, and receiving, from the pre-trained language model, a third test step set of the target interface, wherein the third test step set is generated by the pre-trained language model and based on the interface information of the target interface and the third prompt, and the third prompt being usable to prompt the pre-trained language model to randomly generate a test step set of the target interface; and
executing at least some of test steps in the third test step set.

4. The method of claim 1, wherein the method further comprises:
displaying the target interface with a browser during execution of at least some of test steps in a target test step set of the target interface, wherein the target test step set includes at least one of the first test step set, the second test step set, or the third test step set; and
in response to completing each of at least a portion of the target test step set of the target interface, taking a screenshot of the target interface to obtain a test effect image indicating a test effect of the target interface.

5. The method of claim 1, wherein the method further comprises:
storing at least some of test steps in a target test step set of the target interface in a database for storing historical test steps of the target interface, wherein the target test step set includes at least one of the first test step set, the second test step set, and the third test step set.

6. The method of claim 1, wherein executing at least some of test steps in a target test step set of the target interface comprises:
determining whether there is an inexecutable test step in the target test step set, wherein the target test step set includes at least one of the first test step set, the second test step set, or the third test step set;
in response to determining there is an inexecutable test step in the target test step set, sending, to the pre-trained language model, notification information corresponding to the target test step set to instruct the pre-trained language model to regenerate a new test step for an interface object to which the inexecutable test step in the target test step set is directed;
receiving the new test step from the pre-trained language model; and
in response to determining that the new test step is executable, executing an executable test step and the new test step in the target test step set, wherein the executable test step is a test step other than the inexecutable test step in the target test step set.

7. The method of claim 1, wherein the method further comprises:
in response to a jump from the target interface to an associated interface of the target interface, sending, to the pre-trained language model, at least interface information of the associated interface, wherein the jump occurs after each of at least some of a target test step set of the target interface is completed, and the target test step set includes any of the first test step set, the second test step set, and the third test step set;
receiving, from the pre-trained language model, a test step set of the associated interface; and
executing at least some of test steps in the test step set of the associated interface.

8. A computer device, wherein the computer device comprises:
a memory and a processor, wherein the memory and the processor are connected to each other through communication, the memory stores computer instructions, and the computer instructions cause the processor to:
in response to receiving a first test request, obtain interface information of a target interface of a target business, and obtain background knowledge information of the target business;
send, to a pre-trained language model, the interface information of the target interface, the background knowledge information, and a first prompt, and receive, from the pre-trained language model, a first test step set of the target interface, wherein the first test step set is generated by the pre-trained language model and based on the background knowledge information, the interface information of the target interface and the first prompt, and the first prompt is used to prompt the pre-trained language model to generate a test step of the target interface based on the background knowledge information and the interface information of the target interface; and
execute at least some of test steps in the first test step set.

9. The device of claim 8, wherein the processor is further caused to:
in response to receiving a second test request, send, to the pre-trained language model, the interface information of the target interface, a historical test step set of the target interface, and a second prompt, and receive, from the pre-trained language model, a second test step set of the target interface, wherein the second test step set is generated by the pre-trained language model and based on the interface information of the target interface, the historical test step set of the target interface and the second prompt, the second prompt is used to prompt the pre-trained language model to generate a test step set comprising at least one difference test step of the target interface, the difference test step is different from a historical test step in the historical test step set that corresponds to the difference test step, and the difference test step and the historical test step that corresponds to the difference test step are for a same interface object in the target interface; and
execute at least some of test steps in the second test step set.

10. The device of claim 9, wherein the processor is further caused to:
in response to receiving a third test request, send, to the pre-trained language model, the interface information of the target interface and a third prompt, and receive, from the pre-trained language model, a third test step set of the target interface, wherein the third test step set is generated by the pre-trained language model and based on the interface information of the target interface and the third prompt, and the third prompt is used to prompt the pre-trained language model to randomly generate a test step set of the target interface; and
execute at least some of test steps in the third test step set.

11. The device of claim 8, wherein the processor is further caused to:
display the target interface with a browser during execution of at least some of test steps in a target test step set of the target interface, wherein the target test step set is one of the following: the first test step set, the second test step set, or the third test step set; and
in response to completing each of at least some of the target test step set of the target interface, take a screenshot of the target interface to obtain a test effect image indicating a test effect of the target interface.

12. The device of claim 8, wherein the processor is further caused to:
store at least some of test steps in a target test step set of the target interface in a database for storing historical test steps of the target interface, wherein the target test step set is one of the following: the first test step set, the second test step set, and the third test step set.

13. The device of claim 8, wherein the computer instructions causing the processor to execute at least some of test steps in a target test step set of the target interface comprises instructions to:
determine whether there is an inexecutable test step in the target test step set, wherein the target test step set is one of the following: the first test step set, the second test step set, or the third test step set;
in response to determining there is an inexecutable test step in the target test step set, send, to the pre-trained language model, notification information corresponding to the target test step set, to instruct the pre-trained language model to regenerate a new test step for an interface object for which the inexecutable test step in the target test step set is directed;
receive the new test step from the pre-trained language model; and
in response to determining that the new test step is executable, execute an executable test step and the new test step in the target test step set, wherein the executable test step is a test step other than the inexecutable test step in the target test step set.

14. The device of claim 8, wherein the processor is further caused to:
in response to a jump from the target interface to an associated interface of the target interface, send, to the pre-trained language model, at least interface information of the associated interface, wherein the jump occurs after each of at least some of a target test step set of the target interface is completed, and the target test step set is any of the following: the first test step set, the second test step set, and the third test step set;
receive, from the pre-trained language model, a test step set of the associated interface; and
execute at least some of test steps in the test step set of the associated interface.

15. A non-transitory computer-readable storage medium, wherein the computer-readable storage medium stores computer instructions, and the computer instructions cause a computer to:
in response to receiving a first test request, obtain interface information of a target interface of a target business, and obtain background knowledge information of the target business;
send, to a pre-trained language model, the interface information of the target interface, the background knowledge information, and a first prompt, and receive, from the pre-trained language model, a first test step set of the target interface, wherein the first test step set is generated by the pre-trained language model and based on the background knowledge information, the interface information of the target interface and the first prompt, and the first prompt is used to prompt the pre-trained language model to generate a test step of the target interface based on the background knowledge information and the interface information of the target interface; and
execute at least some of test steps in the first test step set.

16. The medium of claim 15, wherein the computer is further caused to:
in response to receiving a second test request, send, to the pre-trained language model, the interface information of the target interface, a historical test step set of the target interface, and a second prompt, and receive, from the pre-trained language model, a second test step set of the target interface, wherein the second test step set is generated by the pre-trained language model and based on the interface information of the target interface, the historical test step set of the target interface and the second prompt, the second prompt is used to prompt the pre-trained language model to generate a test step set comprising at least one difference test step of the target interface, the difference test step is different from a historical test step in the historical test step set that corresponds to the difference test step, and the difference test step and the historical test step that corresponds to the difference test step are for a same interface object in the target interface; and
execute at least some of test steps in the second test step set.

17. The medium of claim 16, wherein the computer is further caused to:
in response to receiving a third test request, send, to the pre-trained language model, the interface information of the target interface and a third prompt, and receive, from the pre-trained language model, a third test step set of the target interface, wherein the third test step set is generated by the pre-trained language model and based on the interface information of the target interface and the third prompt, and the third prompt is used to prompt the pre-trained language model to randomly generate a test step set of the target interface; and
execute at least some of test steps in the third test step set.

18. The medium of claim 15, wherein the computer is further caused to:
display the target interface with a browser during execution of at least some of test steps in a target test step set of the target interface, wherein the target test step set is one of the following: the first test step set, the second test step set, or the third test step set; and
in response to completing each of at least some of the target test step set of the target interface, take a screenshot of the target interface to obtain a test effect image indicating a test effect of the target interface.

19. The medium of claim 15, wherein the computer is further caused to:
store at least some of test steps in a target test step set of the target interface in a database for storing historical test steps of the target interface, wherein the target test step set is one of the following: the first test step set, the second test step set, and the third test step set.

20. The medium of claim 15, wherein the computer instructions causing the computer to execute at least some of test steps in a target test step set of the target interface comprises instructions to:
determine whether there is an inexecutable test step in the target test step set, wherein the target test step set is one of the following: the first test step set, the second test step set, or the third test step set;
in response to determining there is an inexecutable test step in the target test step set, send, to the pre-trained language model, notification information corresponding to the target test step set, to instruct the pre-trained language model to regenerate a new test step for an interface object for which the inexecutable test step in the target test step set is directed;
receive the new test step from the pre-trained language model; and
in response to determining that the new test step is executable, execute an executable test step and the new test step in the target test step set, wherein the executable test step is a test step other than the inexecutable test step in the target test step set.
